(19) United States
(12) Patent Application Publication
(10) Pub. No.: US 2025/0068974 A1
(43) Pub. Date: Feb. 27, 2025

(54) SELF-SUPERVISED AUTOMATED PIPELINE FOR LARGE SCALE ROBOTIC INDUCTION

(71) Applicant: Osaro, San Francisco, CA (US)

(72) Inventors: William Davidson Richards, San Francisco, CA (US); Khashayar Rohanimanesh, San Francisco, CA (US); Kitt L. Miller, San Francisco, CA (US); Keith Hardaway, San Francisco, CA (US); Ben Goodrich, San Francisco, CA (US); Volodymyr Ladnik, San Francisco, CA (US)

(73) Assignee: Osaro, San Francisco, CA (US)

(21) Appl. No.: 18/796,464

(22) Filed: Aug. 7, 2024

Related U.S. Application Data
(60) Provisional application No. 63/520,968, filed on Aug. 22, 2023.

(51) Int. Cl. G06N 20/00; G05B 13/02

(52) U.S. Cl. CPC G06N 20/00; G05B 13/0265

(57) ABSTRACT

A computer-implemented system for fully automating the training, auto-tuning, and deployment of machine learning models at customer sites, especially models for robotic grasping tasks. The system automatically: (1) detects/predicts performance degradation of one or more machine learning models; (2) triggers a new model training/fine-tuning job in response to such detection/prediction; and (3) deploys the new model upon training completion, without stopping or pausing the production line.

### CROSS-REFERENCE TO RELATED APPLICATIONS

This application claims priority to U.S. Prov. Pat. App. No. 63/520,968, entitled, “Self-Supervised Automated Pipeline for Large Scale Robotic Induction,” filed on Aug. 22, 2023, which is incorporated by reference herein.

### BACKGROUND

Large scale robotic induction involves autonomous induction of hundreds of thousands of object types, or SKUs onto sorters using an AI controlled robotic system (generally a mechanical arm). In such systems generally machine learning models are trained to predict feasible grasp points within a designated pick area often using visual sensory inputs (e.g., RGB and depth images). The problem generally involves grasping of a diverse set of novel objects, which are often packed randomly inside a bin. A common model-free bin picking approach is based on learning grasp prediction models-deep neural networks that map an image of the bin to success probabilities for different grasps. Known approaches require humans in the loop for annotation and are not suitable for fully automated systems. In contrast, some known approaches are self-supervised and do not require humans in the loop. They generally rely on learning from random trials and using a measurement of grasp quality as supervision and hence, they are more suitable for a fully automated pipeline.

Nevertheless, both approaches are known to suffer from the “covariate shift” problem, which is the problem of model performance degradation due to the change in the distribution of the object types (or SKUs) in the training data vs production data. This type of distribution shift commonly happens in commerce due to, for example, seasonal requests, changes in order fulfillments from present to future, and emergence of new sellers with new products. It is not realistic to assume access to the full data to train one model for all. Typically, most current solutions require to stop the system, collect more data (over unseen examples), re-train a new model, and finally deploy it. This is not a desirable solution because, among other reasons: (1) it causes hard system pauses, which will halt the production line and hurt the throughput; (2) all the steps are manual and require a human in the loop, which will not render the solution scalable with increasing production lines and SKUs.

What is needed, therefore, are improved techniques for updating the training of models in response to covariate shift and other performance degradation.

### SUMMARY

A computer-implemented system for fully automating the training, auto-tuning, and deployment of machine learning models at customer sites, especially models for robotic grasping tasks. The system automatically: (1) detects/predicts performance degradation of one or more machine learning models; (2) triggers a new model training/fine-tuning job in response to such detection/prediction; and (3) deploys the new model upon training completion, without stopping or pausing the production line.

Other features and advantages of various aspects and embodiments of the present invention will become apparent from the following description and from the claims.

### BRIEF DESCRIPTION OF THE DRAWINGS

FIG. 1 is a graph illustrating how new and unseen item sets or SKUs that are introduced into a robotic grasping environment at different times may cause degradation in grasp performance, and how embodiments of the present invention may be used to detect and improve grasp performance under such conditions.

FIG. 2 is an example of a robotic system implemented according to one embodiment of the present invention.

FIG. 3 is a diagram of a system implemented according to one embodiment of the present invention for automatically detecting/predicting performance degradation of one or more machine learning models used to control the robot(s) in the system of FIG. 2; updating the training of one or more such models; and redeploying the retrained model(s) without pausing or stopping the system of FIG. 2.

FIG. 4 is a flowchart of a method performed by one embodiment of the present invention to identify performance degradation of a machine learning model and to retrain and deploy that model after retraining.

### DETAILED DESCRIPTION

A computer-implemented system for fully automating the training, auto-tuning, and deployment of machine learning models at customer sites, especially models for robotic grasping tasks. The system automatically: (1) detects/predicts performance degradation of one or more machine learning models; (2) triggers a new model training/fine-tuning job in response to such detection/prediction; and (3) deploys the new model upon training completion, without stopping or pausing the production line.

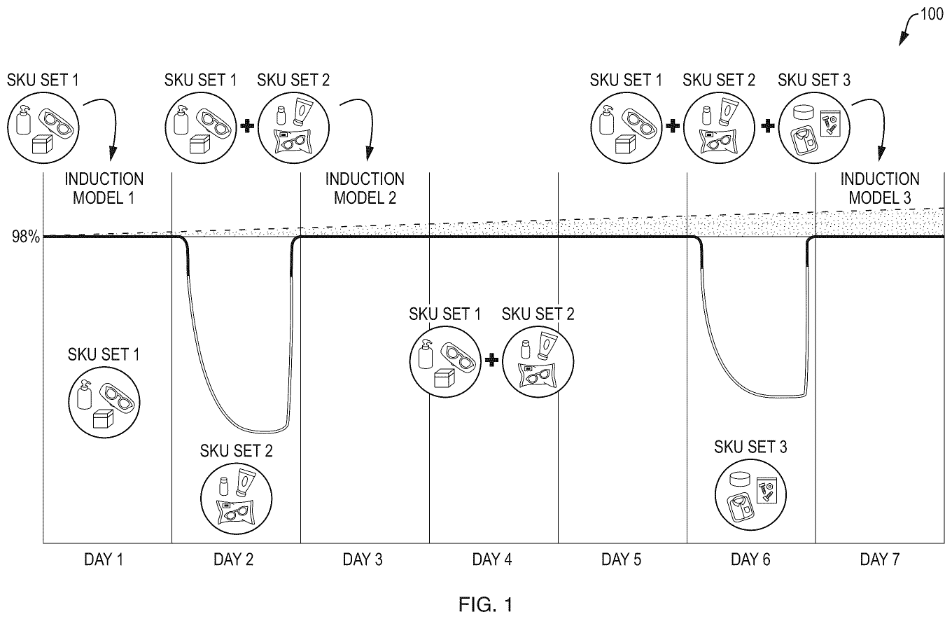

FIG. 1 is a graph 100 which illustrates how new and unseen item sets or SKUs that are introduced into a robotic grasping environment at different times may cause degradation in grasp performance (e.g., dips on days 2 and 6). FIG. 1 also schematically depicts how a system implemented according to an embodiment of the present invention may detect or predict performance degradation and automatically launch new model training jobs using the previous and new data (e.g., on day 2, it uses data covering both SKU set 1 and SKU set 2) in response to such detection or prediction. Once the new models are trained, the system evaluates the models, and selects the best model based on the evaluation, and uploads the selected best model to the robot. As a result, the system drives up performance as long as the objects are drawn from the same distribution of the objects which were used during training (e.g., SKU set 1 and SKU set 2 on days 3, 4, and 5).

At a later time, the system may detect or predict another performance degradation (e.g., on day 6 with unseen SKU set 3), in response to which the system may repeat the process above. Such automatic detection/prediction, retraining, and redeployment may occur any number of times.

The dotted line in FIG. 1 projects the robot performance over a long time: as the robot collects more and more data, the machine learning models learn to generalize better, and the performance degradation diminishes over time. Also note that, for the same reason, the amount of performance degradation will also diminish over time (e.g., the dip on day 6 is lower than the dip on day 2). Instead, the system removes these hurdles by fully automating these steps without requiring human intervention or stopping the production line. More specifically, the system may automatically: (1) detect/predict performance degradation by monitoring performance over the recent and past data; (2) trigger new model training/fine-tuning jobs if a performance degradation is detected; (3) upon training completion, add the new model(s) to a model roster and deploy the best model without stopping or pausing the production line.

In summary, embodiments of the present invention implement a service that handles core logic for the various steps/reactions required to fully automate a training pipeline.

Having described certain embodiments of the present invention at a high level, particular embodiments of the present invention will now be described in more detail.

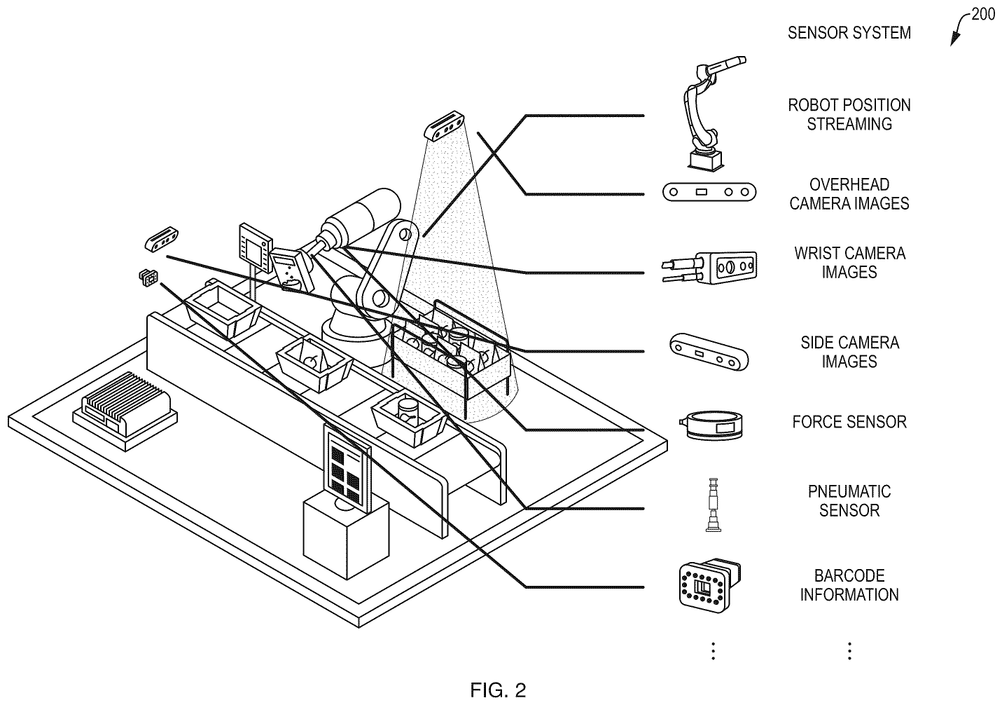

FIG. 2 shows an example of a robotic system 200 implemented according to one embodiment of the present invention. The particular elements of the robotic system 200 are shown merely as examples and do not constitute limitations of the present invention. For example, a robotic system used in conjunction with embodiments of the present invention may include elements not shown in FIG. 2, and need not have all of the elements shown in FIG. 2.

The robotic system 200 may, for example, include one or more robots and one or more sensors for controlling the robot and for training one or more machine learning models. For training machine learning-based grasp prediction models, the main sensory inputs are typically an overhead RGB-D camera positioned over the designated pick area; and tactile, force, and/or pneumatic sensors to measure grasp quality metrics.

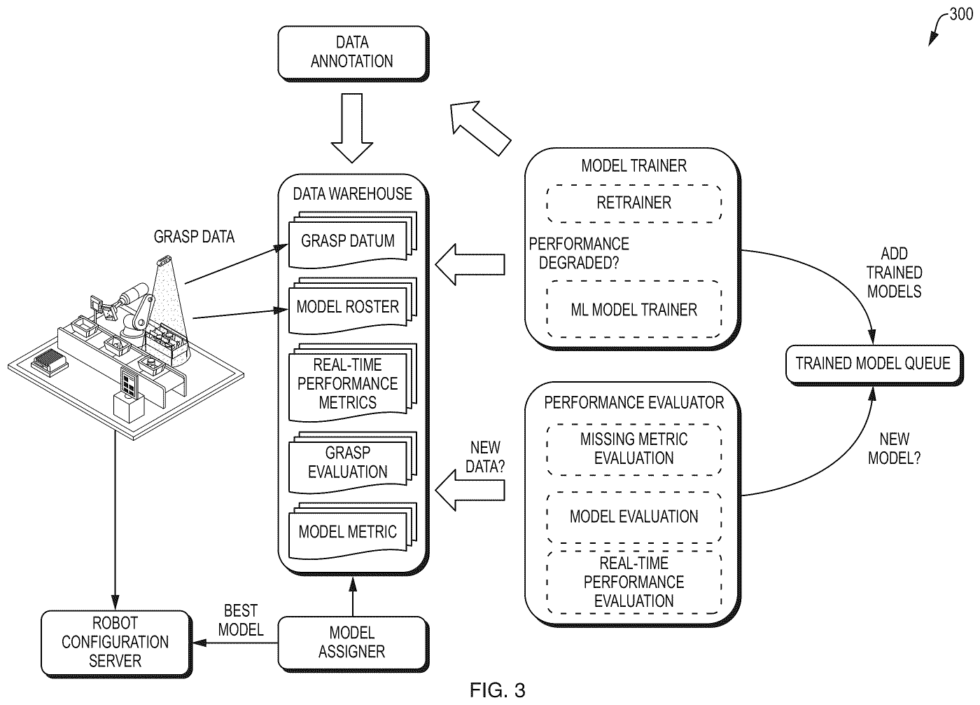

FIG. 3 is a diagram of a system 300 implemented according to one embodiment of the present invention for automatically detecting and/or predicting performance degradation of one or more machine learning models used to control the robot(s) in the system 200 of FIG. 2; updating the training of one or more such models; and redeploying the retrained model(s) without pausing or stopping the system 200 of FIG. 2. For example, one or more robots in the robotic system 200 of FIG. 2 may continue to perform grasping tasks using one or more existing machine learning models while the system 300 of FIG. 3 performs various functions disclosed herein, such as detecting/predicting model performance degradation, retraining models, and redeploying the retrained models. As a result, the robotic system 200 may not have any downtime while the system 300 of FIG. 3 performs the functions disclosed herein.

The robotic system 200 may include computer-controlled hardware (e.g., manipulators and/or mechanical arms) which physically interact with objects in the robotic system 200, and which manipulates those objects according to downstream tasks. The robotic system 200 may, for example, include one or more of the following components:

Robotic Manipulator: a robotic manipulator is a computerized mechanical device (e.g., a mechanical arm) equipped with one or more end-effector manipulators (e.g., vacuum suction or antipodal gripper) responsible for moving materials, parts, and objects.

Sensors: a collection of sensors installed inside the robotic cell for perceiving the current state of the robot workbench. This information is bundled into a grasp datum and is stored in the data warehouse for training and evaluation of the machine learning models. Examples of these sensors include RGB-D cameras, pneumatic sensors (for detecting if a vacuum suction is sealed properly), force sensors, and robot position encoders. A grasp datum may include any of a variety of data, such as one or more of the following, in any combination: one or more images of the bin; one or more images of the object on the end-effector during motion; pneumatic and suction analog sensor readings; antipodal grip sensor readings; force sensor readings; and robot position(s). A grasp datum may also include metadata, such as SKU and/or weight.

High-Level Encoder (HLC): a high level encoder is a computer system that is responsible for running the robot software for autonomously controlling the robotic manipulator and for running the auto model system. This component is also responsible for running the machine learning models which predict feasible grasp proposals for the robot to execute.

An episode of a manipulation task often involves grasping an object from a designated pick area (e.g., a tote, conveyor belt, AMR) and manipulating the object (e.g., barcode scanning, placing in another tote, packing, or assembling).

The system 300 also includes a data warehouse. In general, the data warehouse is a repository of data in which data used by the system 300 are stored and updated. The data warehouse may be implemented using, for example, any one or more of the following: one or more local file systems, Google's Big Query, and Amazon's Athena. During the lifetime of the system 300, the robot may execute grasp proposals generated by machine learning models in the system 300 and store the grasp data in the data warehouse. At the same time, the system 300 may identify and store data representing the best machine learning models in the data warehouse in what is referred to as the “model roster.” The system 300 may evaluate the best models for every new grasp datum generated by the robotic system 200. In particular, in some embodiments of the present invention, the data warehouse includes one or more of the following tables:

Grasp Data Table: For every grasp executed by the robotic manipulator, a collection of sensory inputs are bundled into a grasp datum, which is sent to the data warehouse. The grasp data table stores such grasp data generated by the robot. The grasp data table also stores a set of grasp quality metrics and annotations used to train machine learning models generated by the data annotation component (see below).

Model Roster: The model raster maintains a collection of the best machine learning models in the system 300. Every time the model trainer completes training a new model, the model trainer uploads the model to the model roster.

Grasp Evaluation Table: For any new grasp datum generated by the robotic system 200, the system evaluates the current collection of the best models against that datum and generates a score of that datum per model, based on the evaluation.

Model Metrics Table: The model metrics table maintains the scores of the set of current best models stored in the model roster table. It ingests the rows in the grasp evaluation table and aggregate scores across all data per model and updates each model's overall score. The model metrics table is later queried by the model assigner to infer the current best model across all models to be redeployed to the robotic system 200.

Real-Time Performance Metrics Table: The real time performance metrics table maintains and updates real time performance metrics (e.g., throughput, grasp success rate, cross-entropy, and reject rate) updated by the performance evaluator component.

The system 300 also includes a model trainer. The model trainer is a component that is responsible for detecting/predicting performance degradation and for launching new model training jobs in response to such detection/prediction. In certain embodiments of the present invention, the model trainer may include the following components:

Retrainer: This component implements the logic for submitting new model training requests. It may do that by, for example, querying the model metrics and real time performance metrics tables in the data warehouse and triggering a new model training if performance degradation is detected or predicted. The logic for detecting/predicting and launching new model training jobs may be specific to a particular use case, and various techniques for performing such detection and prediction are well-known to those having ordinary skill in the art. For example, detecting or predicting model performance degradation may include determining when the best model performance trends downward or is below a target threshold.

Machine Learning Model Trainer: The ML model trainer trains machine learning models for use in the robotic system 200. For example, the ML model trainer may use a docker container image which uses TensorFlow for training deep learning models. Upon receiving a training request from the retrainer, the ML model trainer may launch one or a plurality of model training jobs. Every time a trained model becomes available, the ML model trainer publishes the trained model to the model roster table in the data warehouse and notifies the performance evaluator that the trained model is available by publishing a message to the trained model queue.

Note that the system 300 (e.g., the model trainer) may detect/predict performance degradation in any of a variety of ways, such as by using any known techniques for detecting/predicting degradation of performance of a machine learning model.

The system 300 also includes a data annotation component. The data annotation component is responsible for generating annotation for data, stored in the data warehouse, which will be used for training machine learning models. Once the ML model trainer determines that new model training jobs need to be launched, the ML model trainer specifies a data set consisting of a collection of grasp data in the data warehouse. If any of the grasp data are missing annotations, then the ML model trainer requests that the data annotation component annotate that grasp data and update that grasp data in the data warehouse with the annotations.

The data annotation component may be implemented using any of a variety of data annotation techniques. For example, a third party data annotation service may be used to perform some or all of the functions of the data annotation component. Additionally or alternatively, the data annotation component may calculate annotations directly from the sensory inputs in the robotic system 200 as a proxy for ground truth annotation (e.g., in the case of a vacuum suction end-effector, by quantizing the pneumatic sensor into grasp success or failure).

The system 300 also includes a trained model queue. Whenever the ML model trainer completes training a new model, it may notify the performance evaluator of the completed training, thereby triggering evaluation of the newly-trained model. Such evaluation requests may be queued in a queue referred to herein as the trained model queue. The trained model queue may be implemented in any of a variety of ways, such as by using a publish-subscribe system, such as the Google cloud publish-subscribe API.

The system 300 also includes a performance evaluator. The performance evaluator is responsible for updating and tracking the performance of the current collection of machine learning models maintained by the system 300, as stored in the model roster. Any time a new datum is generated by the robot or a new model is trained by the ML model trainer, a new model re-evaluation event may be triggered in order to update the performance metrics with the most recent information. Once all individual grasp quality scores across all models are generated, the grasp quality scores may be aggregated to generate a single score per model.

When a new datum is generated by the robotic system 200 and is uploaded to the data warehouse, it may be incorporated into a sample of data, such as a sample, that is stable, exponentially weighted, and/or moving. One particular example of such a sample is a stable, exponentially weighted, and moving sample. Some or all of the models in the model roster may be evaluated against this sample, and a grasp quality score may be generated for each such evaluation. These grasp quality scores may be saved in the grasp evaluation table. Similarly, when a new model is trained and published to the train complete queue by the ML model trainer, it may be evaluated against a similarly selected sample of grasp data, and the resulting grasp quality scores may be inserted into the grasp score table for the new model.

The use of a stable, exponentially weighted, moving sample, while only an example, is designed to address the challenges of operating at a large scale while maintaining high accuracy and efficiency. For example, given the vast amount of data generated by the robotic system, evaluating every datum is computationally infeasible. The moving sample approach allows the system to focus on a manageable subset of data, reducing computational load and enhancing processing efficiency. By weighting the sample exponentially based on recency, the system prioritizes the most recent data, which is often more reflective of current operational conditions. This ensures that the models are evaluated against data that best represent the present challenges and operational environment, leading to more accurate assessments of model performance. The stability of the sampling method ensures that the data selection process remains consistent over time, which helps in maintaining the integrity of performance comparisons across different models or across different times. By using a determinant sample that updates dynamically yet remains static at each aggregation point, the system ensures that all models are evaluated against the same specific data points at any given evaluation. This approach eliminates randomness in the data used for model comparisons, thereby enhancing the validity and reliability of the evaluation results. The moving sample adapts continuously as new data comes in, ensuring that the dataset used for model evaluation is always up-to-date.

One example of an alternative kind of sampling that may be performed is linear weighted sampling, in which weights are assigned to data points based on their recency, similar to the exponentially weighted approach, but in which the weights decrease linearly rather than exponentially. This means that the most recent data point has the highest weight, and that the weight decreases at a constant rate as the data points get older. Other types of sampling that may be applied include uniform random sampling, stratified sampling, time-based sampling, and cluster sampling.

The evaluations performed by the performance evaluator may be performed after all missing metrics are generated, as described above. The model evaluation may aggregate all individual grasp quality scores across all grasp data, and generate one overall score per model. This score may be stored in the model metrics table, which may be periodically queried by the model assigner to retrieve the best current model in the model roster and to upload that best current model to the robot.

The performance evaluator may generate real time performance metrics (e.g., throughput) and store them in the real time performance metric table in the data warehouse. This table, in combination with the model metrics table, may be used by the retrainer component in the ML model trainer to implement the performance degradation detection and prediction functions disclosed herein.

The system 300 may also include a model assigner. This component is responsible for automatically updating the robot with the current best model. It may do so by periodically querying the model metrics table in the data warehouse for the current best model and updating the HLC configuration to point to the best model in the model roster.

The system 300 may also include a robot configuration server. The robot configuration server may implement a micro service, which provides services for the model assigner to update the HLC configuration with the current best model. The HLC may then replace the current model on the HLC with the new best model without stopping the robot.

Having described various components of the system 300, examples of methods performed by the system 300 will now be described.

While the system 300 is in operation, the robotic system 200 may continuously generate and execute grasps generated by the current grasp prediction model. Without loss of generality, we can assume that the system 300 is warm-started with some pre trained grasp prediction model, which means that there is at least one model stored in the model roster (although this is not required and the system 300 will still operate even without any initial pre-trained grasp prediction model in the model roster). For every grasp, the HLC may collect the sensory input and generate a grasp datum, which may be stored in the grasp data table in the data warehouse.

Concurrently with the above, the performance evaluator may check for new grasp data, run the missing metric evaluation component as described above, and update the grasp quality scores in the grasp evaluation table for every model in the model roster table over the newly generated data. This may be performed at any time(s), e.g., periodically and/or every time a new grasp datum is generated. Once the grasp quality scores have been updated, the model evaluation component may aggregate those scores in the grasp evaluation table across all grasps per model in the model roster table, generate a collection of metrics per model, and store those metrics in the model metrics table. In parallel with, and independently of, the steps just described, the real time performance evaluation component may calculate the real-time performance metrics of the robot (e.g., throughput) and store those performance metrics in the real time performance metrics table.

Concurrently with the steps described above, the model trainer may monitor the system performance metrics, and the retrainer component may use the information stored in the model metrics table and the real-time performance metrics table to decide whether to train a new model in response to detecting or predicting performance degradation. If a decision is made to train a new model, then the ML model trainer launches new model training jobs as needed. In order to launch a new model training job, the ML model trainer may identify an appropriate data set in the data warehouse and send a request to the data annotation component to generate grasp quality metrics and annotations for any grasp datum which is missing an annotation or grasp quality score. When a new model is trained, it may be published to the model roster table, and the performance evaluator may be notified by adding the new model training job request to the trained model queue. This triggers the performance evaluator to repeat the evaluation steps for the new model as described above (e.g., the missing metric evaluation and the model evaluation).

Concurrently with the steps described above, the model assigner component may monitor the model metrics table, and in response to the model assigner component detecting that the performance evaluation component has finished performing a model evaluation, the model assigner component may identify the next best model and submit a request to the robot configuration server to configure the robot HLC with the new best model. Once the HLC is configured, it may fetch the new best model from the model roster table and replace the old model with the new best model retrieved from the model roster.

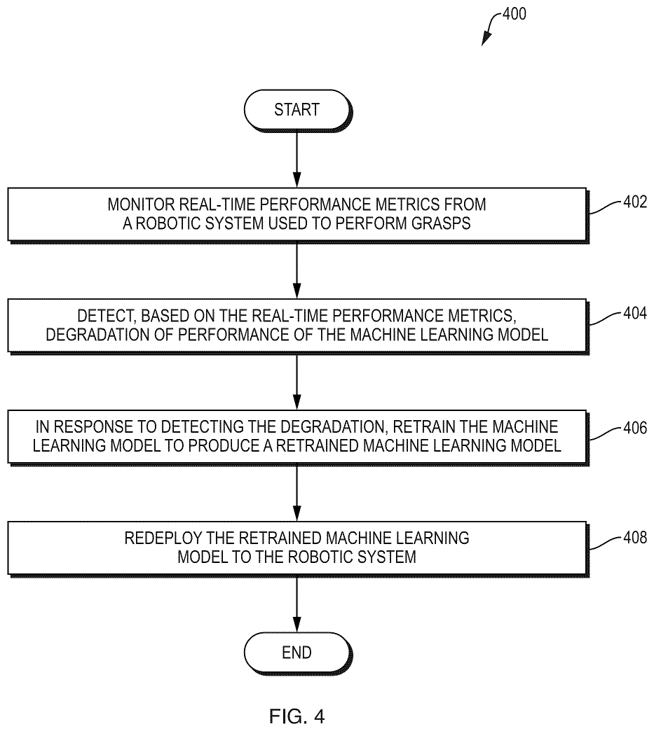

Referring to FIG. 4, a flowchart is shown of a method 400 performed by one embodiment of the present invention. The method 400 may, for example, be performed by one or more computer processors executing computer program instructions that are stored in one or more non-transitory computer-readable media.

The method 400 includes monitoring real-time performance metrics from a robotic system used to perform graphs (FIG. 4, operation 402). The method 400 may detect, based on the real-time performance metrics, degradation of performance of a machine learning model used to control the robotic system (FIG. 4, operation 404). Such detection of performance degradation may, for example, include monitoring and/or analyzing any of a variety of performance indicators that reflect the effectiveness of the machine learning model in controlling the robotic grasping tasks. The purpose of this step is to ensure that the robotic system continues to perform at its intended level of proficiency, and to initiate corrective actions promptly when deviations from expected performance metrics are observed.

The method 400 may detect performance degradation in any of a variety of ways. For example, one approach is to monitor (e.g., continuously) real-time performance metrics, such as any one or more of throughput, grasp success rate, and reject rate. These metrics provide immediate feedback on the operational status of the robotic system and the effectiveness of the machine learning model in executing grasping tasks. For instance, a sudden drop in grasp success rate might indicate issues with the model's current training or an unexpected change in the environment or object properties.

Another method for detecting performance degradation involves comparing the current output of the machine learning model with historical performance data stored in a data warehouse. This comparison helps in identifying trends and patterns that deviate from historical norms. By analyzing these deviations, the method 400 may detect subtle changes in performance that may not be immediately apparent from real-time metrics alone.

As yet another example, performance degradation may be detecting by assessing the performance of the machine learning model against one or more predefined thresholds. Such thresholds may, for example, be set based on the desired performance standards and operational requirements of the robotic system. When the model's performance metric(s) fall below one or more of these thresholds, the method 400 may recognize this as a degradation in performance.

As yet another example, the method 400 may employ statistical analysis, machine learning algorithms, and/or artificial intelligence to predict potential degradation before it becomes significant. These predictive techniques analyze past and current data to forecast future performance, allowing preemptive measures to be taken to avoid noticeable impacts on system operation.

The method 400 may also include, in response to detecting degradation in the performance of the machine learning model, retraining the machine learning model to produce a retrained machine learning model (FIG. 4, operation 406). Retraining the machine learning model is useful for refining the model's capabilities in response to detected performance degradation. In particular, retraining the machine learning model ensures that the robotic system remains efficient and effective in performing grasps, even as conditions change or as the model's initial training becomes less relevant to current scenarios. This retraining process may be used, for example, to update the model with new data, correct any drifts in model accuracy, and optimize performance based on the latest operational insights.

Such retraining of the machine learning model may be performed in any of a variety of ways. For example, such retraining may include updating the machine learning model based on a new data set that includes both previously acquired grasp data and newly collected data. This new data set may include a broader spectrum of examples for the model to learn from, encompassing recent changes in the operational environment and/or variations in the types of objects being grasped. By integrating this new information, the retrained model can better generalize across current and future tasks, thereby improving its overall performance.

The retraining process may be implemented using any of a variety of machine learning techniques, including but not limited to, deep learning methods such as convolutional neural networks (CNNs), transformer models, or recurrent neural networks (RNNs). These techniques are particularly effective in handling complex data patterns and making nuanced adjustments to the model's parameters. For instance, CNNs may be utilized to enhance feature recognition in visual data, which is useful for tasks involving object recognition and grasp point determination.

The retraining may include generating annotations for grasp data that previously lacked annotations. This step may be helpful for ensuring that all data used in the training process is labeled accurately, providing clear feedback to the model regarding the success or failure of past grasps. Annotations may, for example, be generated directly from sensory inputs, such as images from RGB-D cameras or readings from force sensors, serving as a proxy for ground truth data.

The retraining process may be fully automatic (e.g., unless annotation is required), leveraging the capabilities of the system to initiate and carry out model updates without manual intervention. This automation may be facilitated by the integration of a machine learning model trainer component within the system, which manages the execution of training jobs, the application of learning algorithms, and the assessment of training outcomes.

The method 400 may include redeploying the retrained machine learning model to the robotic system (FIG. 4, operation 408). Redeploying the retrained machine learning model ensures the updated model is effectively integrated into the robotic system to enhance its grasping performance. Such redeployment applies the improvements and updates derived from the retraining process directly to the operational environment, thereby enabling the robotic system to benefit from enhanced accuracy and efficiency without interruption to ongoing operations.

“Deploying” or “redeploying” a machine learning model refers to the process of integrating an updated or newly trained machine learning model into the operational framework of a robotic system, enabling it to utilize the latest model for performing tasks such as grasping and manipulating objects. This process ensures that the robotic system operates with the most effective algorithms, reflecting the latest data insights and learning.

Deployment of a machine learning model may involve some or all of the following steps. Initially, the model may be developed and trained offline or in a simulated environment using historical and newly acquired data. Once the model has been trained and validated to meet performance standards, it may then be integrated into the robotic system's operational environment. This integration may involve configuring the system's software to utilize the new model for making decisions and controlling the robotic mechanisms.

Redeployment, on the other hand, refers specifically to the process of replacing an existing model in the robotic system with a retrained or updated version. This is often done in response to detected performance degradation or as part of a regular update cycle to incorporate new data or algorithmic improvements. Redeployment ensures that the robotic system remains at peak efficiency and accuracy, adapting to new conditions or requirements.

The retrained machine learning model may be redeployed in any of a variety of ways. For example, redeployment may include updating the high-level encoder (HLC) configuration of the robotic system. This configuration update may ensure that the robotic system utilizes the newly retrained model instead of the older version. The update process is designed to be seamless and may not require stopping or pausing the robotic system, thus maintaining continuous production or operational flow.

The redeployment may be managed by a model assigner component, which is responsible for periodically querying a model metrics table to identify the best current model based on aggregated performance metrics. This component ensures that only the most effective model, as determined by comprehensive evaluation against real-world data and performance criteria, is deployed to the robotic system.

In addition to updating the HLC configuration, the redeployment process may include a validation phase where the new model is tested in a controlled setting to ensure it performs as expected before full-scale deployment. This testing may include simulated grasping tasks or limited real-world operations under close supervision to monitor the model's performance and ensure it meets all operational standards.

Furthermore, the method 400 may involve a feedback mechanism, in which the performance of the retrained and redeployed model is monitored (e.g., continuously). If any issues are detected post-deployment, or if the model's performance does not meet the expected standards, the system may initiate further retraining cycles. This creates a dynamic and responsive system that evolves in line with changes in the operational environment and ongoing performance requirements.

The redeployment process may be supported by a robot configuration server. This server facilitates the updates to the HLC configuration, ensuring that the transition to the new model is smooth and does not disrupt the robotic system's operations. The server may implement a microservice architecture that provides quick and efficient services for updating the model configurations as needed.

Some or all of operations 402 (detecting model performance degradation), 404 (retraining the model), and 406 (redeploying the model) may be performed without pausing or stopping the robotic system. This capability is useful for maintaining continuous operation, which is particularly beneficial in high-throughput industrial environments where downtime can result in significant operational delays and financial costs.

Not pausing or stopping the robotic system means that the system continues to perform its designated tasks, such as grasping and manipulating objects, while the underlying machine learning models are being monitored, updated, and/or deployed. This may be achieved, for example, using parallel processing and/or real-time data handling. The robotic system's operational components and the machine learning management components operate concurrently, ensuring that updates to the system's intelligence do not interfere with its physical operations.

In some embodiments, the techniques described herein relate to a method performed by at least one computer processor executing computer program instructions stored in at least one non-transitory computer-readable medium, the method including: (A) monitoring real-time performance metrics from a robotic system used to perform grasps; (B) detecting, based on the real-time performance metrics, degradation of performance of a machine learning model used to control the robotic system; (C) in response to the detecting, retraining the machine learning model to produce a retrained machine learning model; and (D) redeploying the retrained machine learning model to the robotic system; wherein (A), (B), and (C) are performed without pausing or stopping the robotic system.

Detecting the degradation of performance of the machine learning model may include determining that the performance of the machine learning model has trended downward over time. Detecting the degradation of performance of the machine learning model may include determining that the performance of the machine learning model falls below a target threshold.

The real-time performance metrics may include at least one of throughput, grasp success rate, cross-entropy score, and reject rate.

Detecting the degradation of performance of the machine learning model may include evaluating performance of the machine learning model based on a comparison of current output of the machine learning model with historical data stored in a data warehouse. Detecting the degradation of performance of the machine learning model may include assessing the performance of the machine learning model against at least one predefined threshold.

Retraining the machine learning model may include updating the machine learning model based on a new data set that includes both previous and newly acquired grasp data. Retraining the machine learning model may include retraining the machine learning model using deep learning. Retraining the machine learning model may include generating annotations for grasp data that lack annotations before retraining the machine learning model.

Generating the annotations may include generating the annotations directly from sensory inputs as a proxy for ground truth annotation.

Redeploying the retrained machine learning model to the robotic system may include updating a high-level encoder (HLC) configuration. Updating the HLC configuration may include periodically querying a model metrics table to identify a best current model. Redeploying the retrained machine learning model may include selecting a best model from a model roster based on aggregated performance metrics. Selecting the best model may include selecting the best model based on an overall score that aggregates individual grasp quality scores across all grasp data.

In some embodiments, the techniques described herein relate to a system including at least one non-transitory computer-readable medium having computer program instructions stored thereon, the computer program instructions being executable by at least one computer processor to perform a method, the method including: (A) monitoring real-time performance metrics from a robotic system used to perform grasps; (B) detecting, based on the real-time performance metrics, degradation of performance of a machine learning model used to control the robotic system; (C) in response to the detecting, retraining the machine learning model to produce a retrained machine learning model; and (D) redeploying the retrained machine learning model to the robotic system; wherein (A), (B), and (C) are performed without pausing or stopping the robotic system.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention monitor the performance of machine learning models for controlling robots to perform grasps in real time, detect/predict performance degradation of such models in real-time, update the training of such models, and redeploy the retrained models for use by the robots, without pausing of stopping the robotic system. Such functions cannot be performed mentally or manually and are inherently rooted in computer technology.

Furthermore, embodiments of the present invention include a variety of innovative features that significantly enhance the functionality and efficiency of robotic systems through the use of machine learning models. These features are designed to address specific technical problems associated with the operation and maintenance of robotic systems in dynamic and demanding environments.

For example, one feature of embodiments of the present invention is the ability to detect performance degradation in machine learning models that control robotic grasping tasks. This feature addresses the technical challenge of maintaining high performance in robotic systems as operational conditions change or as the models themselves become outdated due to shifts in the types of objects handled or changes in the operational environment. Embodiments of the present invention employ monitoring techniques that assess real-time performance metrics and compare these against historical data to accurately identify any decline in model effectiveness.

Another feature of embodiments of the present invention is the automated retraining of machine learning models in response to detected performance degradation. This feature solves the technical problem of model obsolescence and drift, which can lead to decreased efficiency and accuracy in robotic operations. By automatically initiating retraining processes, embodiments of the invention ensure that the robotic system continuously adapts to new data and conditions without human intervention, thereby enhancing the scalability and adaptability of the system.

Embodiments of the invention also include the capability to redeploy retrained machine learning models to the robotic system without pausing or stopping the system. This feature addresses the technical challenge of updating system intelligence without disrupting ongoing operations, which is particularly crucial in high-throughput industrial settings where downtime can result in significant productivity losses. The seamless integration of updated models ensures that improvements are rapidly implemented, maintaining continuous system operation and efficiency.

Each of these features contributes to solving specific technical problems associated with the operation and maintenance of advanced robotic systems. By improving the adaptability, efficiency, and operational continuity of such systems, embodiments of the invention provide significant technological advancements over existing solutions. These features collectively enhance the technical field of robotic automation and machine learning, making embodiments of the invention a valuable and substantial contribution to the state of the art.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

Although terms such as “optimize” and “optimal” are used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

What is claimed is:

1. A method performed by at least one computer processor executing computer program instructions stored in at least one non-transitory computer-readable medium, the method comprising:
(A) monitoring real-time performance metrics from a robotic system used to perform grasps;
(B) detecting, based on the real-time performance metrics, degradation of performance of a machine learning model used to control the robotic system;
(C) in response to the detecting, retraining the machine learning model to produce a retrained machine learning model; and
(D) redeploying the retrained machine learning model to the robotic system;
wherein (A), (B), and (C) are performed without pausing or stopping the robotic system.

2. The method of claim 1, wherein detecting the degradation of performance of the machine learning model comprises determining that the performance of the machine learning model has trended downward over time.

3. The method of claim 1, wherein detecting the degradation of performance of the machine learning model comprises determining that the performance of the machine learning model falls below a target threshold.

4. The method of claim 1, wherein the real-time performance metrics include at least one of throughput, grasp success rate, cross-entropy score, and reject rate.

5. The method of claim 1, wherein detecting the degradation of performance of the machine learning model includes evaluating performance of the machine learning model based on a comparison of current output of the machine learning model with historical data stored in a data warehouse.

6. The method of claim 1, wherein detecting the degradation of performance of the machine learning model includes assessing the performance of the machine learning model against at least one predefined threshold.

7. The method of claim 1, wherein retraining the machine learning model includes updating the machine learning model based on a new data set that includes both previous and newly acquired grasp data.

8. The method of claim 1, wherein retraining the machine learning model comprises retraining the machine learning model using deep learning.

9. The method of claim 1, wherein retraining the machine learning model includes generating annotations for grasp data that lack annotations before retraining the machine learning model.

10. The method of claim 9, wherein generating the annotations comprises generating the annotations directly from sensory inputs as a proxy for ground truth annotation.

11. The method of claim 1, wherein redeploying the retrained machine learning model to the robotic system includes updating a high-level encoder (HLC) configuration.

12. The method of claim 11, wherein updating the HLC configuration comprises periodically querying a model metrics table to identify a best current model.

13. The method of claim 1, wherein redeploying the retrained machine learning model comprises selecting a best model from a model roster based on aggregated performance metrics.

14. The method of claim 13, wherein selecting the best model comprises selecting the best model based on an overall score that aggregates individual grasp quality scores across all grasp data.

15. A system comprising at least one non-transitory computer-readable medium having computer program instructions stored thereon, the computer program instructions being executable by at least one computer processor to perform a method, the method comprising:
(A) monitoring real-time performance metrics from a robotic system used to perform grasps;
(B) detecting, based on the real-time performance metrics, degradation of performance of a machine learning model used to control the robotic system;
(C) in response to the detecting, retraining the machine learning model to produce a retrained machine learning model; and
(D) redeploying the retrained machine learning model to the robotic system;
wherein (A), (B), and (C) are performed without pausing or stopping the robotic system.

16. The system of claim 15, wherein the real-time performance metrics include at least one of throughput, grasp success rate, cross-entropy score, and reject rate.

17. The system of claim 15, wherein retraining the machine learning model includes updating the machine learning model based on a new data set that includes both previous and newly acquired grasp data.

18. The system of claim 15, wherein retraining the machine learning model includes generating annotations for grasp data that lack annotations before retraining the machine learning model.

19. The system of claim 18, wherein generating the annotations comprises generating the annotations directly from sensory inputs as a proxy for ground truth annotation.

20. The system of claim 15, wherein redeploying the retrained machine learning model comprises selecting a best model from a model roster based on aggregated performance metrics.
